(19) United States
(12) Patent Application Publication
(10) Pub. No.: US 2016/0370472 A1
(43) Pub. Date: Dec. 22, 2016

(54) PORTABLE ELECTRONIC DEVICE AND METHOD FOR LOCATING VEHICLE

(71) Applicant: Joseph C. Nemer, Mayfield Heights, OH (US)

(72) Inventor: Joseph C. Nemer, Mayfield Heights, OH (US)

(21) Appl. No.: 14/740,672

(22) Filed: Jun. 16, 2015

(51) Int. Cl. G01S 19/42; B60L 11/18

(52) U.S. Cl. CPC G01S 19/42; B60L 11/1838; B60L 11/1851

(57) ABSTRACT

Portable electronic devices and methods are presented for preserving the location of a vehicle, in which a geolocation of the portable electronic device is automatically obtained in response to detection of termination of a portable electronic device charging operation, allowing a user to locate a vehicle at which the charging operation was terminated.

### FIELD OF THE INVENTION

The present disclosure relates generally to portable electronic devices.

### BACKGROUND

Portable electronic devices, such as cell phones, smart phones, tablets, laptop computers, portable GPS devices, PDAs and the like have become ubiquitous in modern society, and provide users with a variety of services and features. Many portable electronic devices include on-board location systems such as GPS receivers providing the capability to ascertain a current location of the device, typically in terms of latitude and longitude. The device location may facilitate provision of various services to the user, such as navigation assistance, routing assistance to emergency services and first responders for 911 calls from cell phones, and a variety of other uses by application software running on the portable electronic device. However, conventional electronic devices are largely unhelpful when a user forgets where they parked their car or other vehicle. For example, a user may park their vehicle, walk to one or more different destinations, and forget where the vehicle was parked. Thus, while a GPS-equipped portable electronic device may be useful in helping a user navigate to a known or identifiable location, there remains a need for portable electronic devices that can better assist a user to find their vehicle.

### SUMMARY

Portable electronic device apparatus and methods are disclosed for preserving a vehicle location in a portable electronic device, in which the device detects termination of a charging operation and responsively obtains a geolocation using GPS or other on-board location determination system, and stores the location to facilitate later use in navigating to the location of the vehicle.

### DESCRIPTION OF THE VIEWS OF THE DRAWINGS

The following description and drawings set forth certain illustrative implementations of the disclosure in detail, which are indicative of several exemplary ways in which the various principles of the disclosure may be carried out. The illustrated examples, however, are not exhaustive of the many possible embodiments of the disclosure. Other objects, advantages and novel features of the disclosure will be set forth in the following detailed description when considered in conjunction with the drawings, in which:

FIG. 1 is a system diagram illustrating a portable electronic device with apparatus for vehicle location determination in accordance with one or more aspects of the present disclosure;

FIG. 2 is a simplified schematic diagram illustrating example portable electronic devices in which the vehicle location determination concepts of the present disclosure can be implemented;

FIG. 3 illustrates a portable electronic device connected to a DC charging source during a charging operation in a vehicle;

FIG. 4 illustrates a portable electronic device being disconnected from the DC source in the vehicle to terminate the charging operation of FIG. 3 to initiate vehicle location determination by the portable electronic device;

FIG. 5 illustrates removal of the portable electronic device from the vehicle following termination of the charging operation of FIG. 3;

FIG. 6 is a flow diagram illustrating a method for preserving a vehicle location according to one or more aspects of the present disclosure;

FIG. 7 is a flow diagram illustrating operation of the portable electronic device for assisting a user in navigating to a previously preserved charging termination location to locate a vehicle;

FIG. 8 is a front elevation view illustrating a smart phone portable electronic device with a display rendering previously stored locations or favorites including tag indicators identifying locations corresponding to charging operation terminations; and

FIG. 9 is a front elevation view illustrating the smart phone or portable electronic device allowing a user to select a previously stored location for assisted navigation to locate a vehicle.

### DETAILED DESCRIPTION

One or more embodiments or implementations are hereinafter described in conjunction with the drawings, wherein like reference numerals are used to refer to like elements throughout, and wherein the various features are not necessarily drawn to scale.

The present disclosure provides automated solutions to help portable electronic device users locate a vehicle. The inventor has appreciated that users often plug electronic devices into vehicle-based charging sources, such as cigarette lighter ports, USB communication ports, etc. upon entering a vehicle, and that users generally disconnect the device upon exiting the vehicle. In accordance with one or more aspects of the present disclosure, one or more processors or other form of hardware of a portable electronic device is/are programmed with a vehicle locator application or “app” or otherwise configured to interact with charger/power management circuitry and GPS or other on-board location equipment to detect termination of a device charging operation and automatically obtain geolocation information in response to charging termination detection. The obtained geolocation is then stored in the electronic device for later use by on-board or external navigation applications or systems to assist the user in navigating or returning to the saved location. In this manner, the act of disconnecting the portable electronic device and thereby terminating the charging operation at the vehicle location facilitates returning to that location, even if the user has forgotten where the vehicle is parked.

The vehicle locator application may run continuously in certain implementations, and thereby obtain and store all the locations at which the device was disconnected from a charging source. Moreover, other applications of the device may initiate storage of obtained geolocations for later navigation uses, for example, smart phone applications allowing a user to save a current location as a “favorite” or “point of interest”. Certain embodiments of the vehicle locator techniques and applications of the present disclosure may advantageously associate an identifier or tag the geolocation obtained in response to charging termination to facilitate a user distinguishing such charger termination locations from other stored (e.g., favorite) locations in order to further assist in locating a vehicle. In certain implementations, moreover, the user may be prompted by the device to save the geolocation in response to detection of charging operation termination, for example, to give the user an opportunity to decline saving the location (e.g., where the user terminates charging by disconnecting the device at home or at the office, etc.). The concepts of the present disclosure further facilitate returning to a particular location separate from a vehicle. For example, a user may plug in and charge their portable electronic device 10 at the home of a friend, and then leave to take a walk, with the vehicle locator application of the present disclosure automatically obtaining and saving the friend's home location for use in returning in case the user becomes lost. Thus, the concepts of the present disclosure find utility in connection with situations not involving a parked vehicle, particularly where the charging operation was terminated at a location not easily obtained as a commercial “point of interest” identifiable by conventional GPS navigation devices.

Moreover, certain embodiments automatically wake up or activate the device GPS circuitry or other on-board location determination system components to obtain and store the device geolocation in response to detection of charging operation termination, for example, where the portable electronic device is plugged into a vehicle charging source while turned off or operating in a low power or “sleep” mode. In this manner, the user is provided with the charging termination location information for use, if needed, without having to think about obtaining and storing such information when leaving a vehicle.

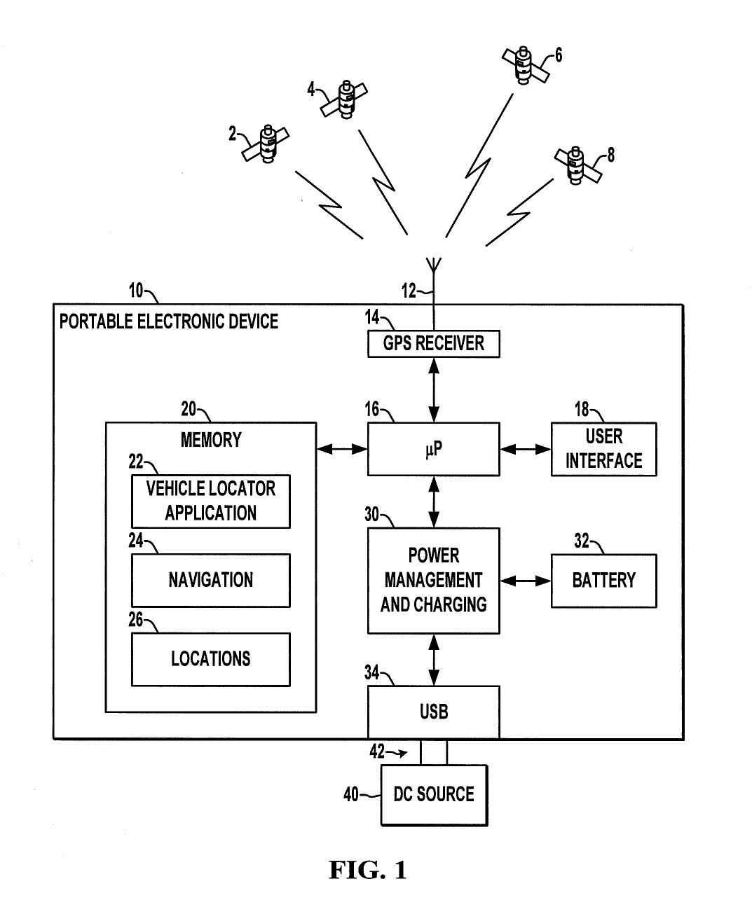

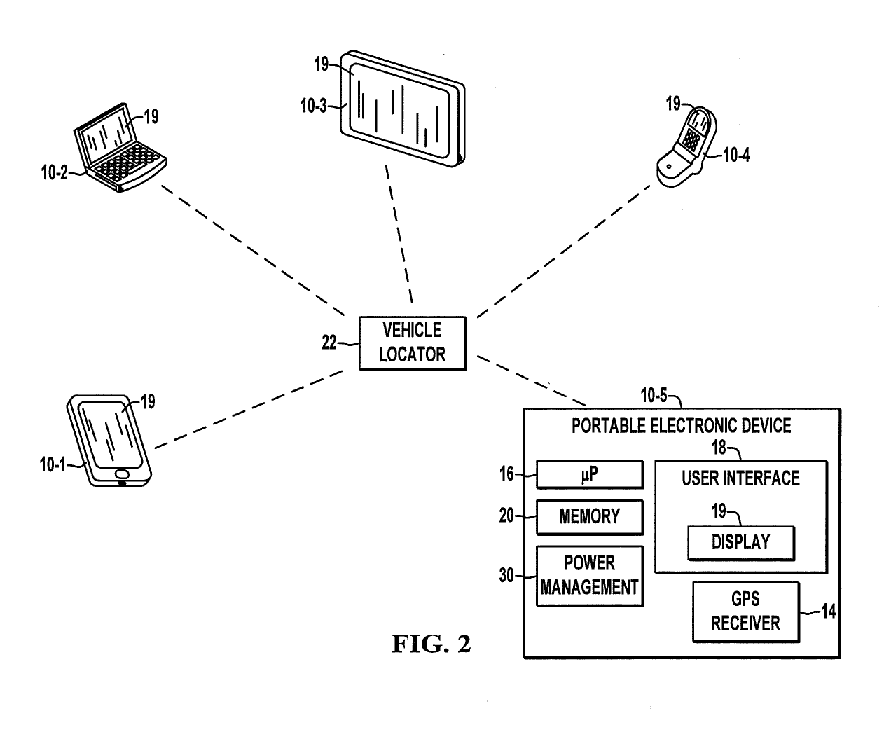

Referring initially to FIGS. 1 and 2, a portable electronic device embodiment 10 is illustrated in which one or more aspects of the present disclosure may be implemented or carried out where the portable electronic device 10 can be any suitable form of electronic processing device wholly or alternatively powered by one or more batteries, charged capacitors, or other power source which can be charged from an external source. FIG. 2 illustrates various non-limiting examples of suitable portable electronic devices 10 include smart phones 10-1, laptop or portable computers 10-2, tablet computers 10-3, cell phones 10-4, or other forms of portable electronic device 10-5 including one or more processing elements such as a microprocessor 16, and associated electronic memory 20, a user interface 18 typically providing a visual display 19, a GPS receiver 14 and power management (e.g., charging) circuitry 30, where the illustrated devices 10 are programmed with computer executable instructions such as a vehicle locator application or “app” 22 as schematically shown in FIG. 2. The vehicle locator application 22 in certain implementations may be downloadable software stored in the electronic memory 20 following purchase and download by a user from an “app store” or other on-line application software server or data store allowing users to purchase applications for use in a portable electronic device 10.

As further shown in FIG. 1, the device 10 includes an antenna 12 operatively coupled with the GPS receiver 14, as well as one or more batteries 32 operatively coupled with the power management and charging circuit 30. The power management circuitry 30 in one example is operatively coupled with a charging port, such as a Universal Serial Bus (USB) connector 34 allowing interconnection of the device 10 to an external DC source 40 via a cable 42, where the port 34 may provide data lines for serial data transfer in addition to power transfer lines, for example, as is typical of many USB circuits 34. As also shown in FIG. 1, moreover, the device memory 20 may be provisioned with many software applications, such as a navigation application 24, and may also locally store one or more locations 26 identified via the location determination apparatus 14 where the locations 26 provide one or more data values suitable for unique identification of an associated location, for example, in terms of latitude and longitude (and possibly altitude), referred to herein as geolocations.

Although the illustrated portable electronic device 10 is described herein with respect to GPS location determination systems, including an antenna 12, a GPS receiver 14, and associated programmed processor 16, any suitable form of location determination apparatus may be employed in the device 10 by which the device location information 26 can be obtained and stored in the memory 20 and/or displayed to a user via the user interface 18. In particular, GPS or other satellite-based navigation systems can be used, which operate based on satellite acquisition and tracking via the three or more satellites 2, 4, 6 and 8 as schematically shown in FIG. 1. Non-limiting examples of suitable forms and types of satellite-based navigation systems include the Global Positioning System (GPS), Galileo, Global Navigation Satellite System (GLONASS), the BeiDou Navigation Satellite System (BDS), Quasi-Zenith Satellite System (QZSS), etc. In the illustrated example, the GPS receiver 14 is operatively coupled with the processor 16 and with the antenna 12 to receive signaling and information from GPS satellites 2, 4, 6 and 8, and is programmed via a navigation application 24 to determine the device location information 26 (e.g., latitude and longitude and optionally elevation or altitude) using triangulation or other techniques from the data received via the antenna 12 and receiver 14 from the satellites 2, 4, 6 and 8.

The device may employ a single processor 16 and/or may include multiple processors and/or other wireless transceivers and various communications circuitry, for example, to implement a number of different functions including without limitation wireless telecommunications (e.g., 3G, 4G, etc.) for placing and receiving calls, Internet access, media streaming, texting, and/or for implementing various known computer functions, etc. The processor 16 may be any suitable microprocessor, microcontroller, processor core, programmable logic, or other form of hardware, etc., and may be configured or programmed with suitable programming instructions such as software and/or firmware to implement the functionality set forth herein along with other tasks associated with satellite-based geolocation and navigation and other device functions, where the programming instructions may be stored in the electronic memory 20 along with various information and data including the locations 26 as illustrated in FIG. 1 in certain embodiments. In particular, the processor 16 in this example is programmed to perform various geolocation processing for determining the current device geolocation based on data and information received from satellites 2, 4, 6 and 8 while implementing GPS satellite location, acquisition and tracking functions. The device 10 also includes some form of user interface 18 allowing interaction with a user, including a graphical display 19, where the user interface 18 may comprise a touch screen display 19 along with one or more other user input features such as a detachable or integral keyboard, track pad, speakers, microphone, etc., and/or the touchscreen display 19 may be implemented so as to provide all the user input and output capabilities. The user device 10 moreover, may include various connectivity features, non-limiting examples of which include network ports for wired connection to a network router, wireless capabilities allowing wireless connection to Bluetooth, Wi-Fi, 3G, 4G or other forms of wireless radio access network, with the ability to connect to one or more external networks such as the Internet.

The user device 10 is further equipped with suitable power circuitry including the battery 32, power management and charging circuitry 30 and a port or connector/terminal 34 for external power source connection. In one possible embodiment, the circuitry 30 includes a DC to DC converter (not shown) to convert received DC input power from a connected external DC charging source 40 via a cable 42. The received input power is used during charging operations for charging the internal battery or batteries 32 and/or for directly or indirectly powering the processor(s) 16 and other circuitry of the portable device 10 when connected, with a power management IC or related circuitry operative to manage battery charging and/or device operation using external power. As used herein, a charging operation includes charging of the battery or batteries 32 from the external source 40 (directly or indirectly via one or more DC to DC converters (not shown)) and/or powering of the electronic device 10 (directly or indirectly) using external power from a connected source 40, for example, when the battery 32 is fully charged.

In addition, the power management and charging circuit 30 detects the presence or absence of provided or available power from a connected DC source 40 and provides a corresponding indication to the processor or other form of hardware 16, and thus to the vehicle locator application 22, when a charging operation is terminated through disabling of the external source 40 or disconnection of the external source 40 from the portable electronic device 10. In one possible embodiment, the power management circuit 30 provides a signal to the processor or other form of hardware 16 (directly or indirectly) having a first state indicating connection of available power from an external source 40 and a second state indicating no external power is available, where the implementation of the vehicle locator application 22 by the processor or other form of hardware 16 monitors such received signal for transitions from the first state to the second state to indicate termination of a charging operation. In another possible embodiment, the power management and charging circuit 30 provides a message to the processor or other form of hardware 16 for use by the vehicle locator application 22, which indicates that previously available power from an external source 40 has been discontinued or has now become unavailable. Other embodiments are possible in which the circuit 30 provides other forms of indication or notification to the processor or other form of hardware 16 (or analog circuitry) indicating termination of previously available external power, whether by sensing a direct charging signal or inferred from one or more signals or device conditions.

As discussed further below, the vehicle locator application 22 in certain embodiments is executed by the processor or other form of hardware 16 whenever the device 10 is receiving power from the external source 40, whether the device 10 is fully operational or in a power down or “sleep” mode, and the processor or other form of hardware 16 may be configured by the computer-executable instructions associated with the vehicle locator application 22 in order to initiate operation of the GPS receiver 14 upon receiving an indication from the power management circuit 30 that an external source 40 has been disconnected from the device 10 or that provision of external power to the device 10 has otherwise been discontinued (i.e. termination of a charging operation). In this manner, the vehicle locator application 22 implemented by the processor or other form of hardware 16 automatically detects termination of a charging operation, and in response to the detected charging operation termination automatically obtains a geolocation of the portable electronic device 10 using the GPS receiver 14 and electronically stores the geolocation 26 in the memory 20 for later use by the application 22 and/or by a navigation application 24.

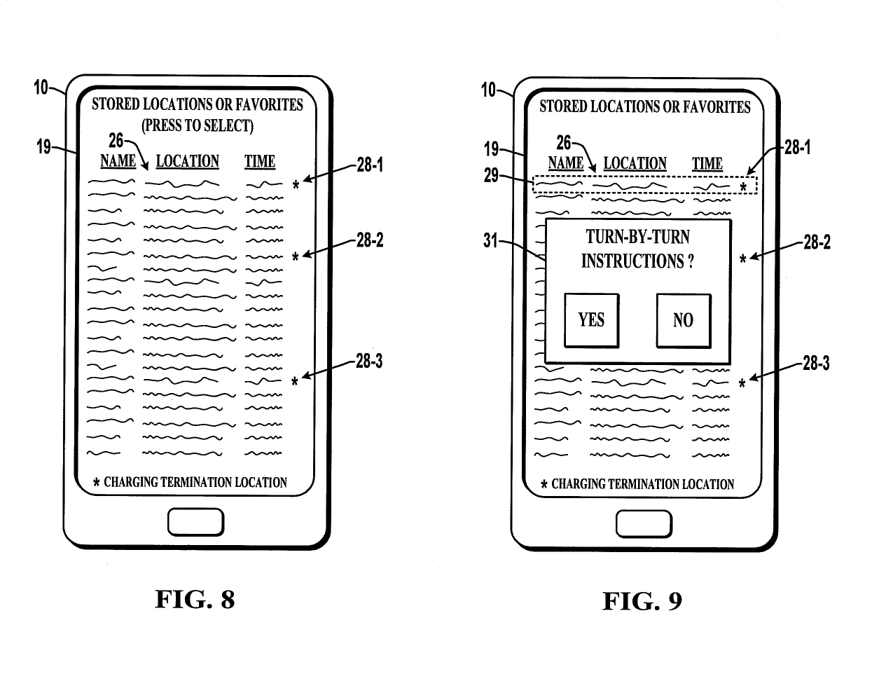

In addition, the processor or other form of hardware 16 in certain embodiments executes instructions of the vehicle locator application 22 in order to automatically associate an identifier or tag 28 (e.g., as further shown in FIGS. 8 and 9 below) with the saved geolocation 26 to thereby indicate that this particular geolocation 26 was saved in response to charging termination to facilitate easy selection by a user who wants to find their vehicle or otherwise return to a charging termination location. In certain implementations of the vehicle locator application, moreover, the processor or other form of hardware 16 may prompt the user before saving the geolocation 26, and may accordingly power up or enable one or more features of the user interface 18 for such prompting if the device 10 was in a low power or sleep mode when the charging termination was detected. In this manner, the user may be provided with an opportunity to prevent storage of a geolocation 26 when the charging operation was terminated at home or at the office, etc.

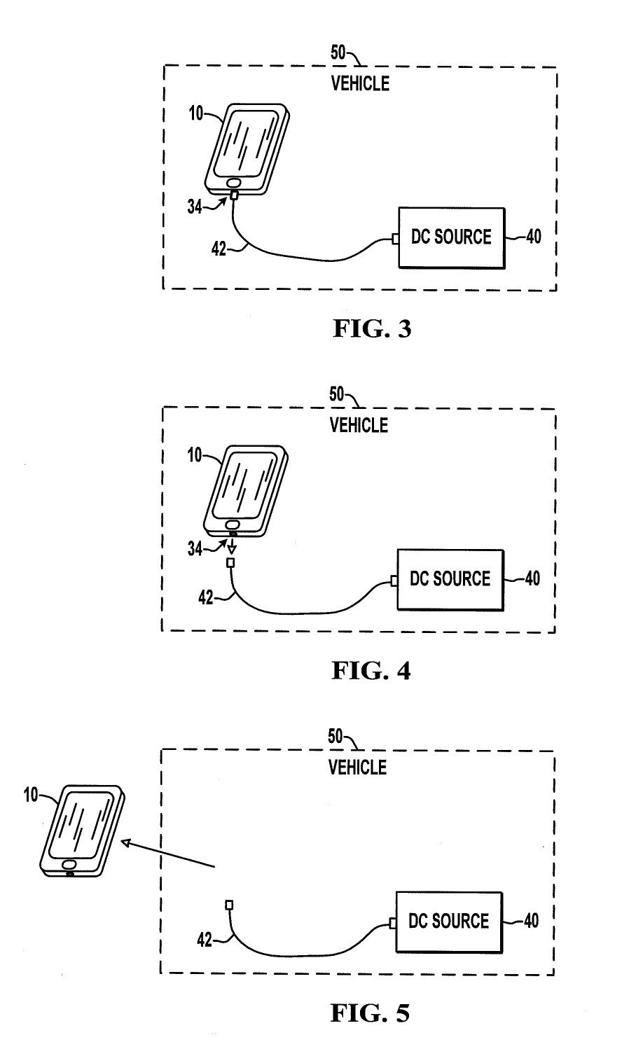

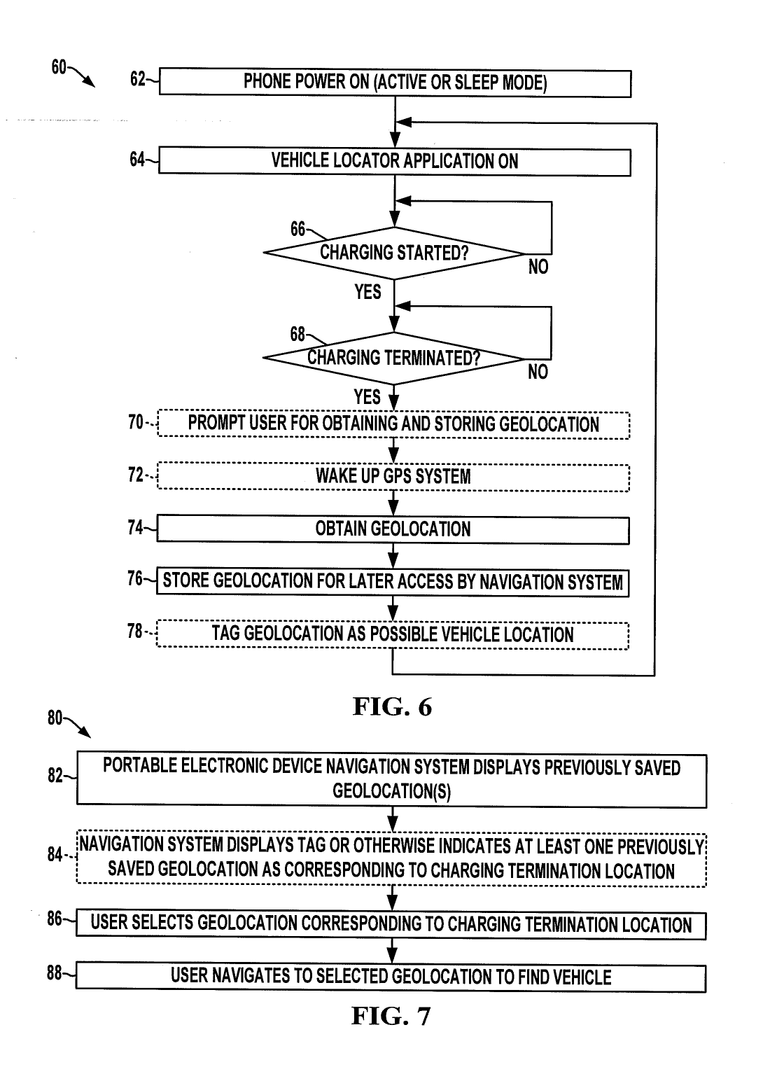

Referring now to FIGS. 3-6, FIGS. 3-5 illustrate connection of a portable electronic device 10 to an external DC source 40 in a vehicle 50 using a cable 42 (FIG. 3) and subsequent disconnection of the cable 42 to terminate a charging operation (FIG. 4), followed by removal of the portable electronic device 10 from a vehicle (FIG. 5), and FIG. 6 illustrates an exemplary method or process 60 for preserving a vehicle location 26 in a portable electronic device 10. Although the method 60 is illustrated and described below in the form of a series of acts or events, it will be appreciated that the various methods of the disclosure are not limited by the illustrated ordering of such acts or events. In this regard, except as specifically provided hereinafter, some acts or events may occur in different order and/or concurrently with other acts or events apart from those illustrated and described herein in accordance with the disclosure. It is further noted that not all illustrated steps may be required to implement a process or method in accordance with the present disclosure, and one or more such acts may be combined.

The illustrated method 60 may be implemented in hardware, processor-executed software, processor-executed firmware or combinations thereof, such as in the processor or other form of hardware 16 of the exemplary portable electronic device 10 described above, and may be embodied in the form of non-transitory computer executable instructions 22 stored in a computer readable medium, such as in the memory 20 operatively associated with the device processor 16 in one example. Moreover, while the operations of the processor-executed vehicle location application 22 in the context of a smart phone portable electronic device (e.g., smart phone 10-1 of FIG. 2), the various concepts of the present disclosure may be carried out in other forms of portable electronic devices 10 including without limitation a laptop computers, tablet computers, cell phones, PDAs, portable GPS-based navigation devices, or other portable electronic device equipped with GPS or other location determination system 14 capable of operation via an on-board chargeable battery.

Referring to FIGS. 3 and 6, the process 60 of FIG. 6 begins at 62 with the phone or other device 10 being powered on, whether in active or sleep mode or other mode in which the processor or other form of hardware 16 and/or the power management circuitry 30 is operational using battery power or externally supplied power. The vehicle locator application 22 begins or continues execution in the processor or other form of hardware 16 at 64 in FIG. 6, and a determination is made by the processor or other form of hardware 16 at 66 as to whether a charging operation has begun or is underway. If not (NO at 66), the processor or other form of hardware 16 and the application 22 continue monitoring the charging operation status at 66. As shown in the connected situation of FIG. 3, if a charging operation is started or continues (YES at 66 in FIG. 6), a determination is made at 68 as to whether the charging operation has terminated, such as by disconnection of the USB cable 42 from the device 10 as shown in FIG. 4. For example, the execution of the application 22 by the processor or other form of hardware 16 includes monitoring a dedicated signal line from the power management and charging circuit 30 for an indication that provision and/or availability of external power from an external DC source 40 has been discontinued. As previously mentioned, other embodiments are possible in which the processor or other form of hardware 16 executes the vehicle locator application 22 including monitoring for receipt of a message or other indication from the power management and charging circuitry 30 that a charging operation has been terminated.

While the charging operation continues (NO at 68), the vehicle locator application 22 continues operation at 68 until an indication has been received that charging has been terminated (YES at 68), after which certain embodiments include the processor or other form of hardware 16 optionally prompting the user for obtaining and/or storing the geolocation at 70. As previously mentioned, this advantageously allows a user to selectively forgo obtaining and/or storing the device location in situations where a charging operation has been terminated at home or in the office, etc., where the process may then return to 66 as discussed above if the user chooses not to obtain and store the current location.

Where the user chooses to obtain and store the current location of the device 10, or in embodiments that do not provide for user prompting at 70, the process 60 proceeds at 72 to optionally wake up the GPS system 14 (if previously in a low power or sleep mode), and the processor or other form of hardware 16 causes the GPS system 14 to obtain the current device geolocation at 74. The geolocation 26 is stored in the electronic memory 20 at 76 in FIG. 6 for later access by the navigation system 24, and the geolocation 26 may optionally be tagged or otherwise associated with an identifier 28 (e.g., FIGS. 8 and 9 below) at 78 in FIG. 6 to indicate that this particular geolocation 26 was saved in response to charging termination. The tag in certain embodiments may be implemented by a date of that associated with the stored geolocation information 26, for example, with a “1” indicating the corresponding geolocation data 26 corresponds to a charging termination location, and a “0” indicating that the geolocation data 26 does not correspond with a charging termination event. The process 60 may then returned to 64 to monitor for further charging operation terminations as described above.

In certain implementations, the vehicle locator application 22 can be an add-on to a navigation application 24 and/or may otherwise cooperatively interact with a navigation application 24 such that the geolocations 26 stored in the memory 20 by the vehicle locator application 22 in response to charging operation terminations is made available to the navigation application 24 of the device 10. The above-described operation of the vehicle locator application 22 advantageously facilitates locating the position or geolocation 26 of the vehicle 50 in FIG. 5 when a user has disconnected a portable electronic device 10 from a vehicle-based DC charging source 40 and removed the device 10 from the vehicle 50 as shown in FIGS. 4 and 5.

Referring now to FIGS. 7-9, FIG. 7 illustrates a flow diagram 80 showing operation of the navigation system 24 and/or the vehicle locator application 22 when a user needs assistance in finding a vehicle 50, and FIGS. 8 and 9 illustrate example user interface display screens rendered to a user via a graphical display 19 of the portable electronic device 10. At 82 in FIG. 7, the device navigation system application 24 is executed by the processor or other form of hardware 16 to display or otherwise render (e.g., visually, audibly, etc.) previously saved geolocations 26 to the user. As seen in FIG. 8, for example, the user is presented with a listing of geolocations 26 along with optional names and time stamps, preferably sorted with the most recent location on top, and the user is prompted for selection of one of the locations for navigation assistance to return to that location.

As previously noted, where a user has charged their portable electronic device in a vehicle 50 and subsequently left the vehicle (thereby terminating the charging operation), the vehicle locator application 22 will have obtained and electronically stored the corresponding vehicle location 26 at the place where the electronic device 10 was disconnected and removed from the vehicle 50. In addition, as seen in FIG. 8, certain embodiments provide a tag or other indication 28 for stored geolocation's 26 corresponding to a charging termination location, where the navigation system displays the tag 28 or otherwise indicates at least one previously saved geolocation as corresponding to a charging termination location at 84 in FIG. 7. For instance, the example of FIG. 8 shows three such charging termination locations and corresponding tags or identifiers 28-1, 28-2 and 28-3, with the location 26 corresponding to the identifier 28-1 being the most recent charging termination location. This allows the user to easily choose one of the previous charging locations and optionally request navigation assistance from the device 10 (e.g., via they on-board navigation application 24 in certain examples) to return to that location 26.

At 86 in FIG. 7, the user selects a geolocation 26 corresponding to one of the charging termination locations. For example, the user in FIG. 9 presses the indicated location associated with the tag identifier 28-1 (e.g., the most recent charging termination location in this example), and the user selection is indicated on the device display 19 by a rectangular box indicator or other indicia 29. In this example, moreover, the device 10 provides a prompting “pop-up” window 31 to ask the user if turn-by-turn instructions are desired. The user then navigates to the selected geolocation 26 to find the vehicle 50 at 88 in FIG. 7. It will be appreciated that other embodiments are possible in which the vehicle locator application 22 provides for display of one or more previously saved charger termination locations 26, and may indicate the locations 26 in terms of latitude and longitude or other information which can be employed with an external navigation system to return to the location of the vehicle 50. The navigation application 24 in the illustrated example can provide any suitable navigation assistance to the user, including turn-by-turn instructions rendered on the display screen 19 and/or audibly enunciated to the user in any suitable fashion, and/or the display screen 19 may be used to provide map interface renderings as are known to show the current position of the user and/or the selected charging termination geolocation 26 on a map to assist the user to return to that location 26. Thus, the user is provided with a simple solution to facilitate returning to the location of the vehicle where the charging of the portable electronic device 10 was terminated.

As previously mentioned, moreover, the vehicle locator application 22 provides significant utility in association with smart phones, cell phones or other GPS equipped portable electronic devices 10, as these are typically charged by users upon entering a vehicle 50, and are often removed from the vehicle 50 when the user exits. It will be further appreciated that the concepts of the present disclosure provide particular utility in connection with other forms of portable electronic devices 10. For example, users traveling to a previously unvisited location (e.g., while on vacation) may bring a portable GPS navigation device, which is plugged into a vehicle-based DC charging source 40 for navigation assistance while driving. The user may then park the vehicle 50 to walk to one or more locations, using the portable GPS navigation device 10 to provide navigation assistance while walking. Implementation of the above-describe vehicle locator application 22 on such a portable GPS navigation device 10 advantageously obtains and stores the geolocation 26 corresponding to the place where the user exited the vehicle 50, thereby facilitating a return to that location 26 where a user has become disoriented or otherwise forgets where they parked the vehicle 50.

The above examples are merely illustrative of several possible embodiments of various aspects of the present disclosure, wherein equivalent alterations and/or modifications will occur to others skilled in the art upon reading and understanding this specification and the annexed drawings. In addition, although a particular feature of the disclosure may have been disclosed with respect to only one of multiple implementations, such feature may be combined with one or more other features of other embodiments as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

1. A method for preserving a vehicle location in a portable electronic device, the method comprising:
automatically detecting termination of a charging operation of the portable electronic device;
in response to detecting termination of the charging operation, automatically obtaining a geolocation of the portable electronic device using a location determination system of the portable electronic device; and
electronically storing the geolocation of the portable electronic device.

2. The method of claim 1, comprising automatically associating an identifier with the saved geolocation to indicate the geolocation was saved in response to charging termination.

3. The method of claim 2, comprising prompting a user to save the geolocation of the portable electronic device.

4. The method of claim 3, comprising activating or waking up the location determination system of the portable electronic device in response to detecting termination of the charging operation.

5. The method of claim 1, comprising prompting a user to save the geolocation of the portable electronic device.

6. The method of claim 5, comprising activating or waking up the location determination system of the portable electronic device in response to detecting termination of the charging operation.

7. The method of claim 1, comprising activating or waking up the location determination system of the portable electronic device in response to detecting termination of the charging operation.

8. A non-transitory computer readable medium comprising computer executable instructions for:
automatically detecting termination of a charging operation of the portable electronic device;
in response to detecting termination of the charging operation, automatically obtaining a geolocation of the portable electronic device using a location determination system of the portable electronic device; and
electronically storing the geolocation of the portable electronic device.

9. The non-transitory computer readable medium of claim 8, comprising computer executable instructions for automatically associating an identifier with the saved geolocation to indicate the geolocation was saved in response to charging termination.

10. The non-transitory computer readable medium of claim 9, comprising computer executable instructions for prompting a user to save the geolocation of the portable electronic device.

11. The non-transitory computer readable medium of claim 10, comprising computer executable instructions for activating or waking up the location determination system of the portable electronic device in response to detecting termination of the charging operation.

12. The non-transitory computer readable medium of claim 8, comprising computer executable instructions for prompting a user to save the geolocation of the portable electronic device.

13. The non-transitory computer readable medium of claim 12, comprising computer executable instructions for activating or waking up the location determination system of the portable electronic device in response to detecting termination of the charging operation.

14. The non-transitory computer readable medium of claim 8, comprising computer executable instructions for activating or waking up the location determination system of the portable electronic device in response to detecting termination of the charging operation.

15. A portable electronic device, comprising:
a location determination apparatus operative to determine a geolocation of the portable electronic device;
a power management component or system operative to detect termination of a charging operation associated with the portable electronic device;
an electronic memory; and
at least one processor or other form of hardware configured to:
automatically detect termination of a charging operation of the portable electronic device;
in response to detecting termination of the charging operation, automatically obtain a geolocation of the portable electronic device using a location determination system of the portable electronic device; and
electronically store the geolocation of the portable electronic device in the electronic memory.

16. The portable electronic device of claim 15, wherein the at least one processor or other form of hardware is configured to automatically associate an identifier with the saved geolocation to indicate the geolocation was saved in response to charging termination.

17. The portable electronic device of claim 15, wherein the at least one processor or other form of hardware is configured to prompt a user to save the geolocation of the portable electronic device.

18. The portable electronic device of claim 15, wherein the at least one processor or other form of hardware is configured to activate or wake up the location determination system of the portable electronic device in response to detecting termination of the charging operation.

19. The portable electronic device of claim 15, wherein the location determination apparatus comprises a Global Positioning System (GPS).

20. The portable electronic device of claim 19, wherein the at least one processor or other form of hardware is configured to activate or wake up the GPS of the portable electronic device in response to detecting termination of the charging operation.
